(19) United States
(12) Patent Application Publication
(10) Pub. No.: US 2025/0296665 A1
(43) Pub. Date: Sep. 25, 2025

(54) PIVOT COLUMN BEARING FOR A PIVOTABLE FIN STABILIZER

(71) Applicants: AKTIEBOLAGET SKF, GOTEBORG (SE); SKF MARINE GMBH, Hamburg (DE)

(72) Inventors: Mathias NOETH, Wasserlosen (DE); Mark NIEDOSTATEK, Wenzendorf (DE); Uwe MÖLLER, Landau (DE); Aaron OTTO, Hamburg (DE); Dennis VOGT, Stelle (DE); Christoph PSYK, Hamburg (DE); Linda SCHULZ, Hamburg (DE); Holger SPARDEL, Hamburg (DE); Joachim MENSCH, Hamburg (DE); Peter WINKLER, Halstenbek (DE); Ralf NIEMEIER, Buxtehude (DE)

(21) Appl. No.: 19/079,665

(22) Filed: Mar. 14, 2025

(30) Foreign Application Priority Data
Mar. 22, 2024 (EP) 24165632.1

(51) Int. Cl. B63B 39/06

(52) U.S. Cl. CPC B63B 39/06

(57) ABSTRACT

A pivot column bearing is provided for a pivotable fin stabilizer of watercraft, the stabilizer having a column pivotable about a vertical axis. The pivot column bearing includes an upper bearing and a lower bearing, the upper and lower bearings being configured to mount the pivot column pivotably about the vertical axis. At least one of the upper bearing and the lower bearing has spherical guide surfaces.

### CROSS-REFERENCE

This application claims priority to European patent application no. 24165632.1 filed on Mar. 22, 2024, the contents of which are fully incorporated herein by reference.

### BACKGROUND OF THE INVENTION

The present invention relates to bearings, and more particularly to a pivot column bearing for a pivotable fin stabilizer.

Fin stabilizers are used to stabilize the roll of a watercraft underway, at anchor or at zero speed and/or to influence the course of the watercraft. Known pivotable fin stabilizers have a stabilizer fin that is pivoted into a fin box in the rest position. In an operating position, the stabilizer fin is pivoted out of the fin box about a pivot axis, and can therefore perform up and down movements about its vertical axis.

The stabilizer fin extends laterally from a pivot column extending along the pivot axis. A bearing referred to as a “pivot column bearing” is provided for the pivotable support of the pivot column. The pivot column bearing typically includes a lower bearing and an upper bearing for guiding the pivot column at its ends. These bearings have cylindrical plain bearing surfaces and are each integrated into wall portions (also known as the top and base plates) of the fin box. The bearings are usually inserted into openings in the wall portions and bolted to these wall portions. The fin box itself is welded into an opening in the hull of the watercraft. Due to thermal stresses occurring during welding, misalignments can occur between the bearings. These misalignments can lead to jamming and/or damage to the bearing.

To compensate for such misalignment, the pivot column bearing is usually provided with a certain amount of axial and/or radial play, in order to prevent damage to the bearings and/or the pivot column and jamming during operation as far as possible. However, if there is no misalignment, or only minimal misalignment, between the bearings, the clearance fit may be too large, which can also lead to damage to the plain bearings and/or pivot column and to a high level of noise. Furthermore, if the play in the pivot column bearing is lost, it may be possible to shim with linear plates or rework the bearings following installation of the fin stabilizer in the vessel in order to prevent or eliminate jamming of the bearing after the vessel has been put into operation.

### SUMMARY OF THE INVENTION

An object of the present invention is to provide a pivot column bearing for a pivotable fin stabilizer of watercraft which automatically compensates for misalignments and enables reliable operation in the event of minimal or no misalignments, as well as to provide a fin stabilizer with an optimally guided stabilizer fin.

This object is achieved by a pivot column bearing comprising an upper bearing and a lower bearing, the upper and lower bearings being configured to mount the pivot column pivotably about the vertical axis, wherein at least one of the upper bearing and the lower bearing has spherical guide surfaces. The object is also achieved by a fin stabilizer having such a pivot column bearing.

In other words, a pivot column bearing for a fin stabilizer of watercraft, according to the present invention, has an upper bearing and a lower bearing for supporting a pivot column of a stabilizer fin which is pivotable about its vertical axis (pivot axis). According to the invention, the upper bearing and/or the lower bearing has/have spherical plain bearing surfaces.

For the purposes of the present disclosure, a “pivot column” is understood to be a device by means of which all forces generated at a stabilizer fin are transferred to the vessel. Due to the sphericity or crowning, misalignments or angular misalignments between the plain bearings can be compensated for with constant play. The compensation takes place automatically without the need for corrective measures or external adjustments. The pivot column bearing according to the present invention can thus be manufactured with an optimum fit. A lubricant supply is formed such that when the load direction is switched, the lubricant is pressed or passed through the bearings and corresponding free spaces like grease. The spherical guide surfaces of the bearings then serve as guides, which significantly reduces or even eliminates a so-called “switching click”.

The spherical plain bearing surface of the lower bearing is preferably formed on a bearing bush that interacts with a cylindrical bearing surface of a pivot column-side bearing ring. The bearing ring, which surrounds the pivot column, is easy to manufacture due to its cylindrical bearing surface. Preferably, the lower bearing is designed as a floating bearing. The bearing bush may be formed of bronze. It is also possible to design the upper bearing as a floating bearing. A floating bearing is a bearing that transmits radial forces exclusively or almost exclusively, i.e., without accounting for friction. It is primarily used to compensate for height differences/displacements.

The manufacture or fabrication of the spherical plain bearing surface of the lower bearing may be simplified if it is made from conical portions and a cylindrical portion. The conical portions can be, for example, oriented to rise in opposite directions to each other and merge into each other through the cylindrical portion. The sphericity of the lower bearing can be adjusted via the angular positions of the conical portions and, in particular, via their length and the length of the cylindrical portion.

In one exemplary embodiment, the lower bearing is designed as a floating bearing. For this purpose, it has a spherical bearing to enable tilting movements of the pivot column and a cylindrical bearing to enable axial displacements of the pivot column.

The spherical plain bearing surface of the upper bearing is preferably formed on a housing-side bearing shell and interacts with a corresponding spherical bearing surface of a pivot column-side bearing ring. The bearing ring is mounted on the pivot column. The fact that these two bearing surfaces are designed to correspond with each other ensures that the bearing ring is guided or supported over a large area on the bearing shell in any angular position, thereby optimizing the introduction of operating loads acting on the stabilizer fin into the vessel structure. Preferably, the upper bearing is designed as a fixed bearing. In principle, however, the lower bearing can also be designed as a fixed bearing. “Fixed bearing” as used herein means the one of the two bearings that transmits both radial forces and axial forces.

In particular, it is advantageous for the radial and axial support of the stabilizer fin if the spherical plain bearing surface of the upper bearing and the corresponding spherical bearing surface are arranged with their lower regions radially being inward of their upper regions. In other words, a center point of the sphere of the bearing shell is located above the bearing shell. The orientation of the “curvature” or the spherical portion is such that its surface area increases from bottom to top.

The bearing ring of the upper bearing may have, on its head portion facing away from the lower bearing, a second spherical bearing surface which is oriented in the opposite direction to the first spherical bearing surface and interacts with a corresponding sliding surface of a radially displaceable bearing cover. As a result of this structure, the upper bearing has two spheres that do not have the same center of rotation. In the event of a deflection caused by misalignment, the bearing cover is displaced radially. The displacement of the bearing cover takes place as compensation during installation, e.g. by welding, of the fin stabilizer in the vessel and is generally only necessary during this phase. The transfer of operating loads into the vessel structure is still ensured by the corresponding surfaces. In particular, a center point of the sphere of the bearing cap is located below the bearing cap. In this exemplary embodiment, the bearing shell is designed in such a way that the pivot column is generally pressed downwardly (i.e., by gravity) during a pivoting movement. This is because pivoting is preferably only carried out when the stabilizer fin is in the neutral position and generates virtually no buoyancy forces. The bearing shell can also transmit radial forces and axial forces, whereas the bearing cap cannot (because it deflects radially).

Preferably, the bearing cover is guided above the bearing shell so as to be capable of displacing radially in relation to the thrust ring. The sliding surface is located between the thrust ring and the bearing cover. Contact between the bearing cover and the bearing shell should be avoided. Ideally, an axial gap is always formed or present between the bearing cover and the bearing shell. Such an axial gap ensures that the bearing cover, which must be able to move radially, is not trapped between the thrust ring and the bearing shell. Due to the axial gap, the two surfaces between the bearing cover and bearing shell are therefore not directly functionally connected.

In particular, the second bearing surface of the upper bearing ring may have a shorter axial extent than the first bearing surface. The bearing cover can be designed to be correspondingly axially short (flat). It has specifically been shown that only the lower sphere transmits loads (weight force) during pivoting movement. The upper sphere can therefore be made smaller. When the stabilizer fin is pivoted into the neutral position, it does not generate any significant (i.e., almost none) lift forces.

### BRIEF DESCRIPTION OF THE SEVERAL VIEWS OF THE DRAWINGS

In the following, a preferred exemplary embodiment of the fin stabilizer according to the invention will be explained in greater detail with the aid of highly simplified figures, in which

FIG. 1 is a longitudinal section through an exemplary embodiment of a pivot column bearing according to the invention;

FIG. 2 is a detailed view of the lower bearing from FIG. 1, designed as a fixed bearing,

FIG. 3 is a schematic view of the lower bearing from FIGS. 1 and 2,

FIG. 4 is a detailed view of the upper bearing from FIG. 1, designed as a fixed bearing; and

FIG. 5 is a detailed view of a lower bearing, designed as a floating bearing.

### DETAILED DESCRIPTION OF THE INVENTION

In the context of the present invention, indications such as “axial” and “radial” refer to a pivot axis or vertical axis of a pivot column of the pivotable fin stabilizer and indications such as “top” and “bottom” refer to the installation position of the fin stabilizer in a vessel. The fin stabilizer is usually welded into the hull at an installation angle of 0° to 45°.

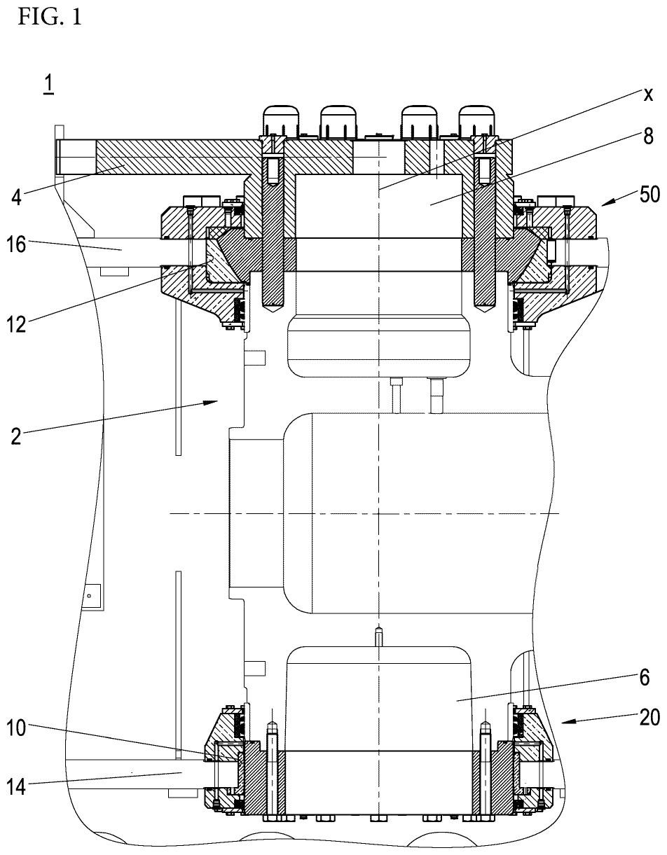

FIG. 1 shows a section along a pivot axis X, preferably a vertical axis, of an exemplary pivot column bearing 1. The pivot column bearing 1 is a component of a fin stabilizer for roll stabilization on vessels. The pivot column bearing 1 enables a pivot column 2, which carries a stabilizer fin (not shown), to be pivoted about the pivot axis X. A pivot arm 4 is attached to the pivot column 2 in order to pivot the column 2, the pivot arm 4 being operatively connected to a suitable motor drive (not shown), for example, a hydraulic or electric motor drive.

The pivot column bearing 1 includes a lower bearing 20 and an upper bearing 50, which each surround a separate end portion 6, 8, respectively, of the pivot column 2 and are inserted in opposite openings 10, 12, respectively, of lower and upper wall portions 14, 16, respectively, of a fin box. In other words, the lower bearing 20 surrounds the end portion 6 of the pivot column 2 and is inserted into the opening 10 of the lower wall portion 14 of the fin box and the upper bearing 50 surrounds the end portion 8 of the pivot column 2 and is inserted into the opening 12 of the upper wall portion 16 of the fin box.

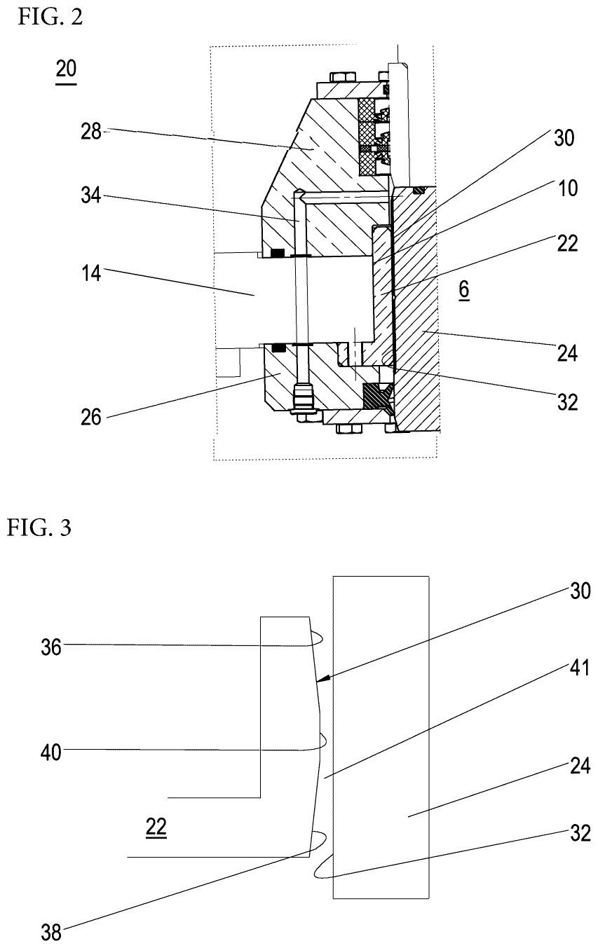

As shown in FIG. 2, the lower bearing 20 includes a bearing bush 22 on the housing side and a bearing ring 24 on the column side. Preferably, the lower bearing 20 is designed or configured as a floating bearing. The bearing ring 24 is firmly attached to the lower end portion 6 of the pivot column 2, for example, screwed to the lower end portion 6, and is rotatably guided in the bearing bush 22. The bearing bush 22 is inserted into the lower opening 10 and is clamped to the lower wall portion 14 by means of an outer ring cover 26 and an inner support bearing cover 28. A lubricant supply 34 is integrated in the lower bearing 20 to supply lubricant to the guide surfaces 30, 32 of the lower bearing 20.

As best shown in FIG. 3, the guide surface or plain bearing surface 30 of the bearing bush 22 of the lower bearing 20 is spherical or quasi spherical. The guide surface or bearing surface 32 of the bearing ring 24, which co-operates with the lower spherical plain bearing surface 30, is cylindrical. In this exemplary embodiment, the sphericity of the surface 30 is preferably achieved by dividing the spherical plain bearing surface 30 into two outer conical portions 36, 38 and a central cylindrical portion 40. The two conical portions 36, 38 are oriented in opposite directions to each other in such a way that the cylindrical portion 40 connects and is located radially inwardly of the conical portions 36, 38. As shown in FIG. 3, an annular gap 41 is defined between the bearing bush 22 and the bearing ring 24 and is useful for the operation of the lower bearing 20.

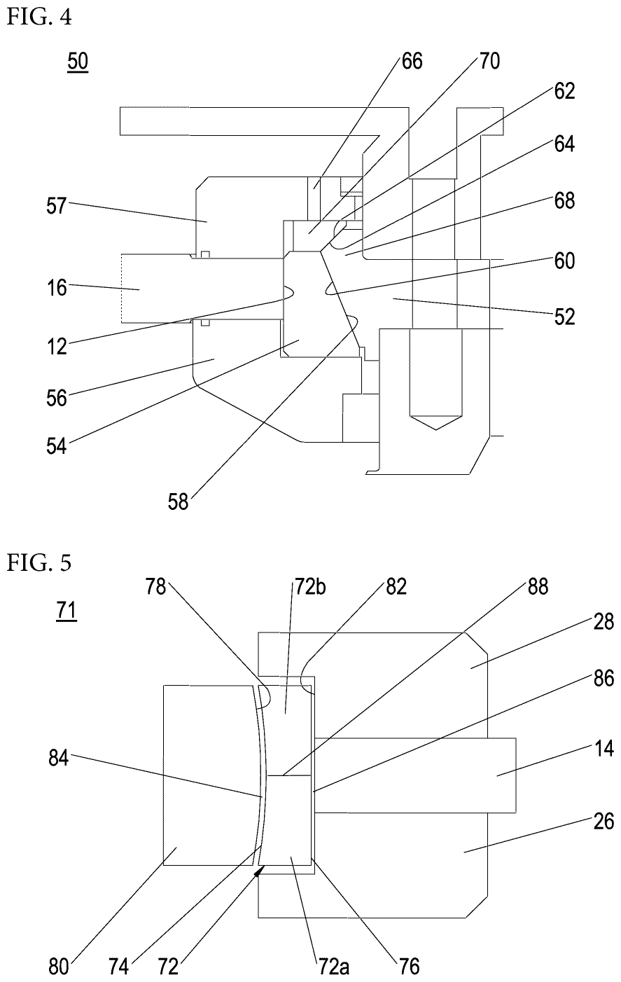

FIG. 4 shows a detailed illustration of the upper bearing 50. Preferably, the upper bearing 50 is designed or configured as a fixed bearing. More specifically, the upper bearing 50 includes a bearing ring 52 on the column side, which surrounds the upper end portion 8 of the pivot column 2 and is firmly connected to the end portion 8. The bearing ring 52 is guided radially in a bearing shell 54 on the housing side. The bearing shell 54 is inserted into the opening 12 of the upper wall portion 16 of the fin box and secured therein against rotation. An outer support bearing ring 56 and an inner thrust ring 57 are clamped to the upper wall portion 16. A lubricant supply (not shown) is provided in the upper bearing 50 to supply lubricant to guide surfaces 58, 60, 62, 64 of the upper bearing 50. An axial bore 66 may be provided in the thrust ring 57 for indirect measurement of axial play.

Each one of the bearing ring 52 and the bearing shell 54 has a spherical guide surface 60, 58, respectively. The spherical guide surface or plain bearing surface 58 of the bearing shell 54 and the spherical guide surface or plain bearing surface 60 of the bearing ring 52 are designed to correspond to or complement each other. The guide/bearing surfaces 58, 60 are oriented toward each other in such a way that their lower regions are arranged radially inwardly in relation to their upper regions.

In addition to the sphericity described above, the upper bearing 50 further has a second sphericity. To provide this second sphericity, the upper bearing ring 52 has a second spherical bearing surface 62 on a head portion 68 facing away from the lower bearing 20, the second spherical bearing surface 62 being oriented in the opposite direction to the first spherical bearing surface 60 and interacting with a corresponding sliding surface 64 of a bearing cover 70. The second bearing surface 62 of the upper bearing ring 52, as well as the sliding surface 64 of the bearing cover 70, has a shorter axial extent than the first bearing surface 60 of the upper bearing ring 52. The bearing cover 70 is supported on the bearing ring 52 and is radially displaceable relative to the thrust ring 57. Contact between the bearing cover 70 and the bearing shell 54 must be avoided. A force acting axially upwardly is transmitted to the thrust ring 57 by means of the bearing cover 70. In particular, a center point of the sphere of the bearing shell 54 is located above the bearing shell 54. A center point of the sphere of the bearing cover 70 is located below the bearing cover 70.

According to the invention, misalignments of the bearings 20, 50 relative to one another are compensated for by the sphericity or crowning of the guide surfaces 30, 32 of the lower bearing 20 and the guide surfaces 58, 60, 62, 64 of the upper bearing 50.

If the pivot column 2 is angled as a result of an alignment error, the column 2 may tilt accordingly due to the sphericity of its bearings 20, 50. Due to its inclination, the upper bearing cover 70 is radially displaced by the head portion of the upper bearing ring 52. The sphericity ensures not only an inclination of the pivot column 2, but in particular a constant/continued maximum possible surface contact between the guide surfaces 30, 32 and 58, 60, 62, 64 and thus an optimum introduction of operating loads acting on the stabilizer fin into the vessel structure.

In FIG. 5, in contrast to the exemplary embodiment in FIGS. 1, 2 and 3, a lower bearing 71 is designed as a floating bearing with two spherical bearing surfaces. For this purpose, the lower bearing 71 has a bearing shell 72 with a radially inner spherical bearing surface 74 and a radially outer cylindrical bearing surface 76. The spherical bearing surface 74 interacts with a corresponding spherical mating surface 78 of a column-side bearing ring 80. The cylindrical bearing surface 76 co-operates with a corresponding cylindrical mating surface 82 of a housing-side ring cover 26, a housing-side support bearing cover 28 and/or a wall portion 14 of the fin box, such that a force is transmitted indirectly via the support bearing cover 28 and the ring cover 26 to the wall portion 14 or is introduced directly into the wall portion 14.

The spherical bearing 74, 78 enables tilting movements of the pivot column 2 shown in FIG. 1. The cylindrical bearing 76, 82 enables axial displacement of the pivot column 2 along its pivot axis X.

In order to prevent the bearing surfaces 74, 78 and 76, 82 from jamming, corresponding bearing gaps 84, 86 are provided between the bearing parts 74, 78 and 76, 82, respectively, which are in sliding contact with one another.

To simplify assembly, the cylindrical bearing 76 may be divided into two parts in the transverse direction (separation plane 88) and thus composed of two halves 72a, 72b. A separation can also be made in the vertical direction (not shown).

Thus, a pivot column bearing for a fin stabilizer of watercraft is disclosed herein, which has at least one spherical plain bearing, as well as a fin stabilizer.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE SIGNS

1 pivot column bearing
2 pivot column
4 pivot arm
6 pivot column end portion
8 pivot column end portion
10 opening
12 opening
14 wall portion fin box
16 wall portion fin box
20 lower bearing
22 bearing bush
24 bearing ring
26 ring cover
28 support bearing cover
30 guide surface or plain bearing surface
32 guide surface or bearing surface
34 lubricant supply
36 conical portion
38 conical portion
40 cylindrical portion
41 annular gap
50 upper bearing
52 bearing ring
54 bearing shell
56 support bearing ring
57 thrust ring
58 guide surface or plain bearing surface
60 guide surface or bearing surface
62 guide surface or second bearing surface
64 guide surface or sliding surface
66 bore for indirect measurement of the axial play
68 head portion
70 bearing cover
71 lower bearing (floating bearing with two spherical surfaces)
72 bearing shell
72a, b bearing shell half
74 spherical bearing surface
76 cylindrical bearing surface
78 spherical mating surface
82 cylindrical mating surface
84 bearing gap
86 bearing gap
88 separation plane
X pivot axis

We claim:

1. A pivot column bearing for a pivotable fin stabilizer of a watercraft, the fin stabilizer having a pivot column pivotable about a vertical axis, the pivot column bearing comprising:
an upper bearing; and
a lower bearing, the upper and lower bearings being configured to mount the pivot column pivotably about the vertical axis;
wherein at least one of the upper bearing and the lower bearing has spherical guide surfaces.

2. The pivot column bearing according to claim 1, wherein the lower bearing includes a bearing bush with a spherical plain bearing surface and a pivot column-side bearing ring with a cylindrical bearing surface, the spherical plain bearing surface cooperating with the cylindrical bearing surface.

3. The pivot column bearing according to claim 2, wherein the spherical plain bearing surface of the bearing bush includes two conical portions and a cylindrical portion disposed between the two conical portions.

4. The pivot column bearing according to claim 1, wherein the lower bearing includes a spherical bearing and a cylindrical bearing.

5. The pivot column bearing according to claim 1, wherein the upper bearing includes a housing-side bearing shell having a spherical plain bearing surface and a pivot column-side bearing ring having a spherical bearing surface, the spherical plain bearing surface of the bearing shell cooperating with the corresponding spherical bearing surface of the bearing ring.

6. The pivot column bearing according to claim 5, wherein the spherical plain bearing surface of the bearing shell and the corresponding spherical bearing surface of the bearing ring each have a lower region arranged radially inwardly relative to an upper region.

7. The pivot column bearing according to claim 5, wherein the bearing ring of the upper bearing has a head portion facing away from the lower bearing, the head portion having a second spherical bearing surface oriented in an opposite direction to the first spherical bearing surface and cooperating with a corresponding spherical sliding surface of a radially displaceable bearing cover.

8. The pivot column bearing according to claim 7, wherein the bearing cover is guided radially displaceable relative to a thrust ring.

9. The pivot column bearing according to claim 7, wherein the second spherical bearing surface of the upper bearing ring has an axial extent less than an axial extent of the first spherical bearing surface.

10. A fin stabilizer with a pivot column bearing according to claim 1.
